(19) United States
(12) Patent Application Publication
(10) Pub. No.: US 2022/0181710 A1
(43) Pub. Date: Jun. 9, 2022

(54) CAPACITOR-ASSISTED LITHIUM-SULFUR BATTERY

(71) Applicant: GM GLOBAL TECHNOLOGY OPERATIONS LLC, Detroit, MI (US)

(72) Inventors: Zhe Li, Shanghai (CN); Yong Lu, Shanghai (CN); Haijing Liu, Shanghai (CN)

(73) Assignee: GM GLOBAL TECHNOLOGY OPERATIONS LLC, Detroit, MI (US)

(21) Appl. No.: 17/542,294

(22) Filed: Dec. 3, 2021

(30) Foreign Application Priority Data
Dec. 4, 2020 (CN) 202011404401.5

(51) Int. Cl. H01M 10/42; H01M 10/0525; H01M 4/38; H01M 4/587

(52) U.S. Cl. CPC H01M 10/4264; H01M 10/0525; H01M 2004/027; H01M 4/587; H01M 4/382

(57) ABSTRACT

The present disclosure relates to capacitor-assisted lithium-sulfur batteries including capacitor electrodes and/or capacitor-based interlayers. For example, a capacitor-assisted lithium-sulfur battery that includes two or more cells is provided. Each cell includes at least two electrodes selected from: a first electrode including a sulfur-containing electroactive material; a second electrode including a negative electroactive material; a first capacitor electrode including a positive capacitor active material; and a second capacitor electrode including a negative capacitor active material. Each electrode may be disposed adjacent to a surface of a current collector and a separator may be disposed between adjacent electrodes so as to provide electrical separation. One of the two or more cells includes the first electrode and the second electrode, and no cell includes both the first electrode and the first capacitor electrode or both the second electrode and the second capacitor electrode. Each cell may further include at least one capacitor-based interlayer.

### CROSS-REFERENCE TO RELATED APPLICATIONS

This application claims the benefit and priority of Chinese Patent Application No. 202011404401.5, filed Dec. 4, 2020. The entire disclosure of the above application is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, Hybrid Electric Vehicles (“HEVs”), and Electric Vehicles (“EVs”). Lithium-sulfur batteries can deliver high energy densities (e.g., up to about 2500 Wh/kg) and are generally available at lower costs and are environmentally friendly. In certain instances, however, lithium-sulfur batteries may have limited rate capabilities, for example, as a result of the insulating nature of sulfur and its reduction products (e.g., in the form of Li₂S and/or Li₂S₂). Accordingly, it would be desirable to develop materials and systems having both high energy densities and increased power capabilities.

### SUMMARY

This section provides a general summary of the disclosure, and is not a comprehensive disclosure of its full scope or all of its features.

The present disclosure relates to a capacitor-assisted lithium-sulfur battery including one or more capacitor electrodes and/or one or more capacitor-based interlayers.

In various aspects, the present disclosure provides a capacitor-assisted lithium-sulfur battery that includes two or more cells. Each cell includes at least two electrodes selected from: a first electrode including a sulfur-containing electroactive material; a second electrode including a negative electroactive material; a first capacitor electrode including a positive capacitor active material; and a second capacitor electrode including a negative capacitor active material. Each electrode may be disposed adjacent to a surface of a current collector and a separator may be disposed between adjacent electrodes so as to provide electrical separation between the first and second electrodes, the first electrode and the second capacitor electrode, the second electrode and the first capacitor electrode, and the first and second capacitor electrodes. One of the two or more cells includes the first electrode and the second electrode, and no cell includes both (together) the first electrode and the first capacitor electrode or both (together) the second electrode and the second capacitor electrode.

In one aspect, the first electrode may further include a sulfur host material.

In one aspect, the first electrode includes greater than or equal to about 20 wt. % to less than or equal to about 98 wt. % of the sulfur-containing electroactive material, and greater than or equal to about 2 wt. % to less than or equal to about 60 wt. % of the sulfur host material.

In one aspect, the sulfur host material may be selected from the group consisting of: carbon nanotubes, amorphous carbon, porous carbon, carbon nanofibers, carbon spheres, carbon nanocage, graphene, graphene oxide, reduced graphene oxide, doped carbon, polyaniline (PAN), polypyrrole (PPy), polythiophene (Pt), polyaniline (PAni), poly(3,4-ethylenedioxythiophene:poly(styrenesulfonate) (PEDOT:PSS), TiO₂, SiO₂, CoS₂, Ti₄O₇, CeO₂, MoO₃, V₂O₅, SnO₂, Ni₃S₂, MoS₂, FeS, VS₂, TiS₂, TiS, CoS₂, Co₉S₈, NbS, VN, TiN, Ni₂N, CrN, ZrN, NbN, TiC, Ti₂C, B₄C, Ni-based-MOFs, Ce-based-MOFs, polypyrrole/graphene, vanadium nitride/graphene, MgB₂, TiCl₂, phosphorene, C₃B, Li₄Ti₅O₁₂, and combinations thereof.

In one aspect, the negative electroactive material includes lithium metal.

In one aspect, the positive capacitor active material may be selected from the group consisting of: activated carbon, graphene, carbon nanotubes, other porous carbon materials, conducting polymers, and combinations thereof.

In one aspect, the negative capacitor active material may be selected from the group consisting of: lithiated activated carbon, lithiated soft carbon, lithiated hard carbon, lithiated metal oxides, lithiated metal sulfides, and combinations thereof.

In one aspect, each cell includes the first electrode and the second electrode, and each cell may further include at least one capacitor-based interlayer.

In one aspect, the at least one capacitor-based interlayer may be disposed between the first electrode and the separator.

In one aspect, the at least one capacitor-based interlayer may include a positive capacitor active material. The positive capacitor active material may be selected from the group consisting of: activated carbon, graphene, carbon nanotubes, other porous carbon materials, conducting polymers, and combinations thereof.

In one aspect, the at least one capacitor-based interlayer may be disposed between the second electrode and the separator.

In one aspect, the at least one capacitor-based interlayer may include a negative capacitor active material. The negative capacitor active material may be selected from the group consisting of lithiated activated carbon, lithiated soft carbon, lithiated hard carbon, lithiated metal oxides, lithiated metal sulfides, and combinations thereof.

In one aspect, the at least one capacitor-based interlayer may include a first capacitor-based layer and a second capacitor-based layer. The first capacitor-based layer may be disposed between the first electrode and the separator. The second capacitor-based interlayer may be disposed between the second electrode and the separator. The first capacitor-based layer may be a positive capacitor-based layer. The second capacitor-based interlayer may be a negative capacitor-based layer.

In one aspect, the at least one capacitor-based layer may have a thickness greater than or equal to about 0.1 μm to less than or equal to about 100 μm.

In various aspects, the present disclosure provides a capacitor-assisted lithium-sulfur electrochemical cell. The capacitor-assisted lithium-sulfur electrochemical cell may include a first current collector having a first surface; a first electrode disposed adjacent to the first surface of the first current collector; a second current collector having a first surface, where the first surface of the second current collector is substantially parallel with the first surface of first current collector; a capacitor electrode disposed adjacent to the first surface of the second current collector; and a separator disposed between the first electrode and the capacitor electrode. The first electrode may include a sulfur-containing electroactive material. The capacitor electrode may include a negative capacitor active material.

In one aspect, the first electrode may include greater than or equal to about 2 wt. % to less than or equal to about 60 wt. % of a sulfur host material.

In one aspect, the negative capacitor active material may be selected from the group consisting of: lithiated activated carbon, lithiated soft carbon, lithiated hard carbon, lithiated metal oxides, lithiated metal sulfides, and combinations thereof.

In various aspects, the present disclosure provides a capacitor-assisted lithium-sulfur electrochemical cell. The capacitor-assisted lithium-sulfur electrochemical cell may include a first current collector having a first surface; a first electrode disposed adjacent to the first surface of the first current collector; a second current collector having a first surface, where the first surface of the second current collector is substantially parallel with the first surface of first current collector; a second electrode disposed adjacent to the first surface of the second current collector; a separator disposed between the first and second electrodes; and a capacitor-based interlayer disposed between one of the first electrode and the separator or the second electrode and the separator. The first electrode may include a sulfur-containing electroactive material. The capacitor-based interlayer may have a thickness greater than or equal to about 0.1 μm to less than or equal to about 100 μm.

In one aspect, the capacitor-based interlayer may be disposed between the first electrode and the separator. The capacitor-based interlayer may include a positive capacitor active material. The positive capacitor active material may be selected from the group consisting of: activated carbon, graphene, carbon nanotubes, other porous carbon materials, conducting polymers, and combinations thereof.

In one aspect, the capacitor-based interlayer may be disposed between the second electrode and the separator. The capacitor-based interlayer may include a negative capacitor active material. The negative capacitor active material may be selected from the group consisting of lithiated activated carbon, lithiated soft carbon, hard carbon, lithiated metal oxides, lithiated metal sulfides, and combinations thereof.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example electrochemical battery cell including a lithium-ion capacitor cathode;

FIG. 2 is a schematic of an example electrochemical battery cell including a lithium-ion capacitor anode;

FIG. 3 is a schematic of an example electrochemical battery cell including an electric double-layer capacitor (EDLC);

FIG. 4 is a schematic of an example electrochemical battery cell having an asymmetric cathode;

FIG. 5 is a schematic of an example electrochemical battery cell having an asymmetric anode;

FIG. 6 is a schematic of an example electrochemical battery cell having a capacitor-based interlayer disposed between a cathode and a separator;

FIG. 7 is a schematic of an example electrochemical battery cell having a capacitor-based interlayer disposed between an anode and a separator; and

FIG. 8 is a schematic of an example electrochemical battery cell having a first capacitor-based interlayer disposed between a cathode and a separator and a second capacitor-based interlayer disposed between an anode and the separator.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology pertains to improved electrochemical cells that include one or more capacitor components or additives and that may be incorporated into energy storage devices, for example lithium-sulfur batteries. Such electrochemical cells may have hybrid structures, so as to integrate the high power capability capacitors with the high energy density of lithium-sulfur batteries. In various instances the electrochemical cells and energy storage devices may be used in, for example, automotive or other vehicles (e.g., motorcycles, boats tractors, buses, motorcycles, mobile homes, campers, and tanks). However, the described electrochemical cells and energy storage devices incorporating such electrochemical cells may also be used in a variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example.

Typical lithium-sulfur batteries include a first electrode (such as a positive sulfur electrode or sulfur cathode) opposing a second electrode (such as a lithium negative electrode or lithium anode) and a separator and/or electrolyte disposed therebetween. The first and second electrodes are connected, respectively, to first and second current collectors (typically a metal, such as copper for the anode and aluminum for the cathode). The current collectors associated with the two electrodes are connected by an external circuit that allows current generated by electrons to pass between the electrodes to compensate for transport of lithium ions across the battery cell. For example, during cell discharge, the internal lithium ion (Li) ionic current from the negative electrode to the positive electrode may be compensated by the electronic current flowing through the external circuit from the negative electrode to the positive electrode of the battery cell. The electrolyte is suitable for conducting lithium ions and, in various aspects, may be in liquid, gel, or solid form.

In various aspects, multiple lithium-sulfur battery cells may be electrically connected in an electrochemical device to increase overall output. For example, lithium-sulfur battery cells may be electrically coupled in a stack or winding configuration to increase overall output. Stacks often include positioning first and second current collectors and corresponding first and second electrodes in alternating arrangements with a separator and/or electrolyte disposed between the electrodes. The current collectors may be electrically connected in a serial or parallel arrangements. In the instance of hybridized or capacitor-assisted lithium-sulfur batteries, a capacitor material that serves a capacitor function may be integrated into the cell stack. For example, in various aspects, the capacitor-assisted batteries may include one or more capacitor components or layers that are parallel or stacked with the one or more of the electrodes of the battery.

Such capacitor-assisted lithium-sulfur batteries may provide several advantages, such as power response, as well as improved long-term performance. For example, power response may be improved by incorporating capacitor component layers or materials. Each of the electrodes, including positive and negative electrodes and capacitor electrodes, within a hybrid battery pack or cell may be electrically connected to a current collector. During battery usage, the current collectors associated with the electrodes are connected by an external circuit that allows current generated by electrons to pass between the electrodes to compensate for transport of lithium ions.

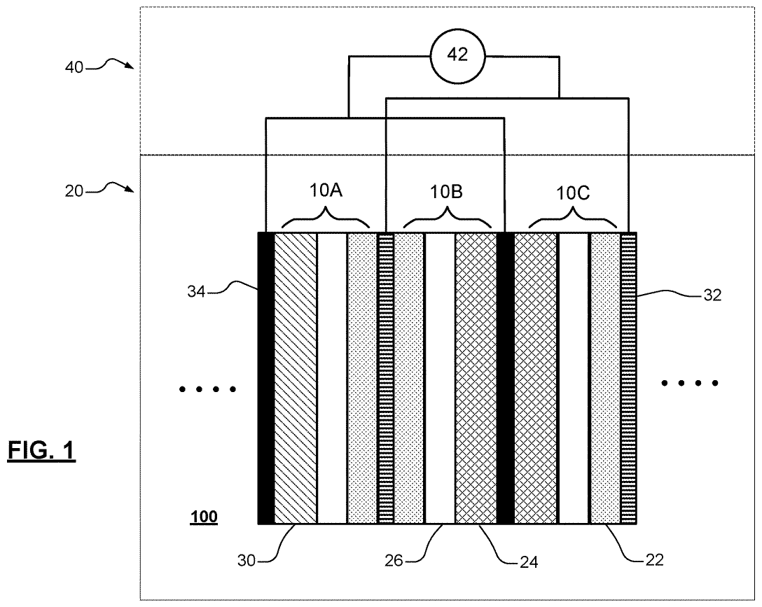

An exemplary and schematic illustration of an example capacitor-assisted lithium-sulfur cell (also referred to as the battery) 20 is shown in FIG. 1. The capacitor-assisted lithium-sulfur battery 20 includes a plurality of cells 10A-10C. Though only three cells are illustrated, the skilled artisan will understand that the present teachings apply to various other battery configurations, including batteries having fewer or more cells, as illustrated by the ellipsis. Each cell 10A-10C includes a negative electrode 22 (e.g., anode), a positive electrode 24 (e.g., cathode), and a separator 26 disposed between the two electrodes 22, 24. At least one of the cells 10A-10C, includes a capacitor electrode (e.g., lithium-ion capacitor cathode) 30 in place of one of the electrodes 22, 24. For example, as illustrated, a capacitor electrode 30 may be disposed in place of the cathode 24 in a first cell 10A. In each instance, the separator 26 provides electrical separation (e.g., prevents physical contact) between the electrodes 22, 24, 30. The separator 26 also provides a minimal resistance path for internal passage of lithium ions, and in certain instances, related anions, during cycling of the lithium ions. In various aspects, the separator 26 comprises an electrolyte 100 that may, in certain aspects, also be present in the negative electrode 22, positive electrode 24, and/or capacitor electrode 30. In certain variations, the separator 26 may be formed by a solid-state electrolyte. For example, the separator 26 may be defined by a plurality of solid-state electrolyte particles (not shown).

A negative electrode current collector 32 may be positioned at or near each negative electrode 22, and a positive electrode current collector 34 may be positioned at or near each positive electrode 24 and/or capacitor electrode 30. The negative electrode current collectors 32 and the positive electrode current collectors 34 respectively collect and move free electrons to and from an external circuit 40. For example, an interruptible external circuit 40 and a load device 42 may connect the negative electrodes 22 (through the negative electrode current collectors 32) and the positive electrodes 24 and/or capacitor electrodes 30 (through the positive electrode current collectors 34).

The negative electrode current collectors 32 may be metal foils, metal grids or screens, or expanded metals comprising copper or any other appropriate electrically conductive material known to those of skill in the art (such as, for example only, aluminum, nickel, iron, titanium tin, and the like). The negative electrode current collectors 32 may have thicknesses greater than or equal to about 4 μm to less than or equal to about 100 μm.

The positive electrode current collectors 34 may be metal foils, metal grids or screens, or expanded metals comprising aluminum or any other appropriate electrically conductive material known to those of skill in the art (such as, for example only, copper, stainless steel, nickel, iron, titanium, and tin, and the like). For example, in certain aspects, the positive electrode current collectors 34 may be two-dimensional current collectors having thicknesses greater than or equal to about 4 μm to less than or equal to about 100 μm and comprising, for example only, aluminum, carbon-coated aluminum, stainless steel, nickel, iron, titanium, copper, tin, and other like conductive materials. In other variations, the positive electrode current collectors 34 may be three-dimensional current collectors having thickness greater than or equal to about 4 μm to less than or equal to about 2000 μm and comprising, for example only, meshed current collector, aluminum foam, nickel foam, copper foam, carbon nanofiber three-dimensional current collector, graphene foam, carbon cloth, carbon fiber-embedded carbon nanotubes, carbon nanotubes three-dimensional current collector (such as, carbon nanotube paper), graphene/nickel foam, and the like.

Though not illustrated, the skilled artisan will appreciate that the present teachings also apply to various other electrode configurations, including for example, capacitor-assisted lithium-sulfur batteries comprising one or more additional negative electrodes, one or more additional positive electrodes, and one or more additional capacitor, capacitor-assisted, or composite electrodes. In each instance, the capacitor-assisted batteries include alternating stacks of negative electrodes interspaced by the positive electrodes or positive capacitor electrodes or stacks of positive electrodes interspaced by negative electrodes or negative capacitor electrodes.

The battery 20 can generate an electric current during discharge by way of reversible electrochemical reactions that occur when the external circuit 40 is closed (to connect the negative electrodes 22 and the positive electrodes 24 and/or the capacitor electrodes 30) and the negative electrodes 22 have a lower potential than the positive electrodes 24. In each instance, the chemical potential difference between the positive electrodes 24 and the negative electrodes 22 drives electrons produced by a reaction, for example, the oxidation of lithium (e.g., lithium metal), at the negative electrodes 22 through the external circuit 40 towards the positive electrodes 24 and/or capacitor electrodes 30. Lithium ions that are produced at the negative electrodes 22 are concurrently transferred through the electrolyte 100 contained in the separator 26 towards the positive electrodes 24 and/or capacitor electrodes 30. The electrons flow through the external circuit 40 and the lithium ions migrate across the separator 26 containing the electrolyte 100 to form Li₂S and/or Li₂S₂ at the positive electrodes 24, for example step by step and/or to be adsorbed by the capacitor electrode 30. As noted above, electrolyte 100 is typically also present in the negative electrode 22 and positive electrode 24. The electric current passing through the external circuit 40 can be harnessed and directed through the load device 42 until the capacity of the battery 20 is diminished.

The battery 20 can be charged or re-energized at any time by connecting an external power source to the battery 20 to reverse the electrochemical reactions that occur during battery discharge. Connecting an external electrical energy source to the battery 20 promotes a reaction, for example, non-spontaneous oxidation of Li₂S and/or Li₂S₂, at the positive electrode 24 and/or the desorption of Li⁺ at capacitor electrodes 30 so that electrons and lithium ions are produced. The lithium ions flow back towards the negative electrodes 22 through the electrolyte 100 across the separator 26 to replenish the negative electrodes 22 with lithium for use during the next battery discharge event. As such, a complete discharging event followed by a complete charging event is considered to be a cycle, where lithium ions are cycled between the positive electrodes 24 and/or capacitor electrodes 30 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many battery 20 configurations, each of the negative electrode current collectors 32, negative electrodes 22, separators 26, positive electrodes 24, positive electrode current collectors 34, and capacitor electrodes 30 can be prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrodes 22, the positive electrodes 24, capacitor electrodes 30, and/or the separator 26. The battery 20 shown in FIG. 1 includes a liquid electrolyte 100 and shows representative concepts of battery operation. However, the current technology also applies to solid-state batteries that include solid-state electrolytes and solid-state electroactive particles that may have a different design, as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion and/or lithium-sulfur cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, the capacitor electrodes 30, and the separator 26 may each include an electrolyte solution or system 100 inside their pores that is capable of conducting lithium ions between the negative electrodes 22 and the positive electrodes 24 and/or capacitor electrodes 30. Any appropriate electrolyte 100, whether in solid, liquid, or gel form, capable of conducting lithium ions between the negative electrodes 22 and the positive electrodes 24 and/or capacitor electrodes 30 may be used in the battery 20. In certain aspects, the electrolyte 100 may be a non-aqueous liquid electrolyte solution that includes a lithium salt dissolved in an organic solvent or a mixture of organic solvents. In certain variations, the electrolyte 100 may further include one or more additives. For example, the electrolyte 100 may include greater than or equal to about 0.01 M to less than or equal to about 1.0 M of the one or more additives. The one or more additives may include, for example only, LiNO₃, Li₂Sₓ (where 4≤x≤8), P₂S₅, phosphorus-containing flame retardant additives (e.g., tris(2,2,2-trifluoroethyl)phosphite (TTFP)), redox mediators (e.g., LiI), and the like. Numerous conventional non-aqueous liquid electrolyte 100 solutions may be employed in the battery 20.

In certain aspects, the electrolyte 100 may be a non-aqueous liquid electrolyte solution that includes one or more lithium salts (e.g., greater than or equal to about 0.5 M to less than or equal to about 20 M) dissolved in an organic solvent or a mixture of organic solvents. For example, a non-limiting list of lithium salts that may be dissolved in an organic solvent to form the non-aqueous liquid electrolyte solution include lithium bis(trifluoromethylsulfonyl)imide (LiTFSI), lithium bis(pentafluoroethanesulfonyl)imide (LiBETI) lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆Hs)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof.

These and other similar lithium salts may be dissolved in a variety of non-aqueous aprotic organic solvents, including, but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane (DME), 1-2-diethoxyethane, ethoxymethoxyethane), cyclic ethers (e.g., tetrahydrofuran, 2-methyltetrahydrofuran, 1,3-dioxolane (DOL)), sulfur compounds (e.g., sulfolane), fluorinated ethers (e.g., 1,1,2,2-tetrafluoroethyle 2,2,3,3-tetrafluoropropyl ether (HFE)), aprotic ionic liquid (e.g., N-methyl-N-butylpiperidinium bis(trifluoromethanesulfonyl)amid ([PP14][TFSI])), solvate ionic liquid (e.g., tetraglyme (G4)), and combinations thereof.

In certain aspects, example electrolyte systems 100 include 1M lithium bis(trifluoromethylsulfonyl)imide (LiTFSI) in 1,3-dioxolane (DOL)/1,2-dimethoxyethane (DME) (1:1 v/v), 1M lithium bis(trifluoromethylsulfonyl)imide (LiTFSI) in 1,3-dioxolane (DOL)/1,2-dimethoxyethane (DME) (1:1 v/v) with 0.1M LiNO₃, and 1.0M lithium bis(trifluoromethylsulfonyl)imide (LiTFSI) in 1,3-dioxolane (DOL)/1,1,2,2-tetrafluoroethyle 2,2,3,3-tetrafluoropropyl ether (HFE) (1:2 v/v), by way of non-limiting example. In other variations, example electrolyte systems 100 are concentrated electrolytes including, for example only, 7M lithium bis(trifluoromethylsulfonyl)imide (LiTFSI) in 1,2-dimethoxyethane (DME)/1,3-dioxolane (DOL), 1M lithium bis(trifluoromethylsulfonyl)imide (LiTFSI) in N-methyl-N-butylpiperidinium bis(trifluoromethanesulfonyl)amid ([PP14][TFSI]), [Li(G4)][TFSI]/4(1,1,2,2-tetrafluoroethyle 2,2,3,3-tetrafluoropropyl ether (HFE)), 0.2M LiOH aqueous solution, and the like.

The separator 26 may be a porous separator having a porosity greater than or equal to about 30 vol. % to less than or equal to about 80%. The separator 26 may be, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of polyethylene (PE) and/or polypropylene (PP). Commercially available polyolefin porous separator membranes include CELGARD® 2500 (a monolayer polypropylene separator) and CELGARD®2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may also be mixed with a ceramic material or its surface may be coated in a ceramic material. For example, a ceramic coating may include alumina (Al₂O₃), silicon dioxide (SiO₂), titania (TiO₂) or combinations thereof. In other variations, the separator 26 may be coated within one or more coatings that are configured to block polysulfide diffusion. For example, the separator 26 may include KETJENBLACK® carbon-coated polypropylene (PP), carbon nanotube-coated polypropylene (PP), graphene oxide-coated polypropylene (PP), graphene-coated polypropylene (PP), MOF-coated polypropylene (PP), MoS₂-coated polypropylene (PP), MoS₂/carbon nanotube-coated polypropylene (PP), MnO-coated polypropylene (PP), Li₄Ti₅O₁₂/graphene-coated polypropylene (PP), and the like. In still other variations, the separator 26 may be polydopamine-coated polyolefin, Nafion-coated polypropylene (PP), nanotube/polyethyleneglycol (PEG)-coated polypropylene (PP), SiO₂/polyethylene oxide (PEO)-coated polypropylene (PP), and the like. Various conventionally available polymers and commercial products for forming the separator 26 are contemplated, as well as the many manufacturing methods that may be employed to produce such a microporous polymer separator 26.

In various aspects, the porous separator 26 and the electrolyte 100 in FIG. 1 may be replaced with a solid-state electrolyte (“SSE”) (not shown) that functions as both an electrolyte and a separator. The solid-state electrolyte may be disposed between the positive electrode 24 and negative electrode 22. The solid-state electrolyte facilitates transfer of lithium ions, while mechanically separating and providing electrical insulation between the negative and positive electrodes 22, 24. By way of non-limiting example, solid-state electrolytes may include LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₈, Li₆PS₈Cl, Li₆PS₈Br, Li₆PS₅I, Li₃OCl, Li_{2.99} Ba_{0.005}ClO, or combinations thereof.

Each negative electrode 22 comprises a lithium material that provides a lithium source that is capable of electrochemical reactions with the sulfur-containing positive electroactive material. For example, the negative electrodes 22 may include negative electroactive materials that comprises lithium, such as, for example, lithium metal. In certain variations, the negative electrodes 22 include one or more films or layers formed of lithium metal or an alloy of lithium. In certain variations, the negative electrodes 22 may be defined by a plurality of negative electroactive material particles (not shown). Such negative electroactive material particles may be disposed in one or more layers so as to define the three-dimensional structure of the negative electrode 22. Other negative electroactive materials that can also be used to form the negative electrodes 22, include, for example, carbonaceous materials (such as graphite, hard carbon, soft carbon), lithium-silicon and silicon containing binary and ternary alloys and/or tin-containing alloys (such as Si, SiOₓ Si—Sn, SiSnFe, SiSnAl, SiFeCo, SnO₂, and the like), and/or metal oxides (such as Fe₃O₄). In certain alternative embodiments, lithium-titanium anode materials are contemplated, such as Li₄₊ₓTi₅O₁₂, where 0≤x≤3, including lithium titanate (Li₄Ti₅O₁₂) (LTO). Such electroactive materials should be lithiated.

In each instance, the negative electroactive material defining the negative electrode 22 may be optionally intermingled with one or more electrically conductive materials that provide an electron conductive path and/or at least one polymeric binder material that improves the structural integrity of the negative electrode 22. For example, the negative electroactive material in the negative electrode 22 may be optionally intermingled with binders such as bare alginate salts, poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), polyacrylate (PAA), lithium polyacrylate (LiPAA), sodium polyacrylate (NaPAA), sodium alginate, lithium alginate, ethylene propylene diene monomer (EPDM), and combinations thereof. Electrically conductive materials may include carbon-based materials, powder nickel or other metal particles, or a conductive polymer. Carbon-based materials may include, for example, particles of carbon black, graphite, acetylene black (such as KETCHEN™ black or DENKA™ black), carbon fibers and nanotubes (e.g., vapor grown carbon fibers (VGCF)), graphene, graphene oxide, and the like. Examples of a conductive polymer include polyaniline, polythiophene, polyacetylene, polypyrrole, and the like.

For example, the negative electrodes 22 may each include greater than or equal to about 30 wt. % to less than or equal to about 99.5 wt. %, and in certain aspects, optionally greater than or equal to about 50 wt. % to less than or equal to about 95 wt. %, of the negative electroactive material; greater than or equal to about 0 wt. % to less than or equal to about 30 wt. %, and in certain aspects, optionally greater than or equal to about 0.5 wt. % to less than or equal to about 15 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders. The negative electrodes 22 may have thicknesses greater than or equal to about 0.2 μm to less than or equal to about 500 μm.

Each positive electrode 24 may be defined by a plurality of electroactive material particles (not shown) disposed in one or more layers so as to define the three-dimensional structure of the positive electrodes 24. For example, the positive electrodes 24 may include a positive electroactive material that comprises sulfur. For example, the positive electrode 24 may include a sulfur-containing electroactive material and a sulfur host material. The positive electrode 24 may include greater than or equal to about 20 wt. % to less than or equal to about 98 wt. %, and in certain aspects, optionally greater than or equal to about 60 wt. % to less than or equal to about 90 wt. %, of the sulfur-containing electroactive material, and greater than or equal to 2 wt. % to less than or equal to about 60 wt. %, and in certain aspects, optionally greater than or equal to about 10 wt. % to less than or equal to about 30 wt. %, of the sulfur host material.

The sulfur-containing electroactive material may include, for example only, S. The sulfur host material may be a carbon-based host, including, for example only, carbon nanotubes, amorphous carbon (e.g., carbon black, such as KETJENBLACK®), porous carbon, carbon nanofibers, carbon spheres, carbon nanocage, graphene, graphene oxide, reduced graphene oxide, doped carbon (e.g., N-doped carbon nanotubes), and hybrids and the like. In certain variations, the sulfur host material may be a conducting polymer-based host, including, for example only, polyaniline (PAN), polypyrrole (PPy), polythiophene (Pt), polyaniline (PAni), poly(3,4-ethylenedioxythiophene:poly(styrenesulfonate) (PEDOT:PSS), and the like. In other variations, the sulfur host material may be a metal oxide-base host including, for example only, TiO₂, SiO₂, CoS₂, Ti₄O₇, CeO₂, MoO₃, V₂O₅, SnO₂, and the like; a metal sulfide-based host including, for example only, Ni₃S₂, MoS₂, FeS, VS₂, TiS₂, TiS, CoS₂, Co₉S₈, NbS, and the like; a metal nitride-based host including, for example only, VN, TiN, Ni₂N, CrN, ZrN, NbN, and the like; metal carbide-based host including, for example only, TiC, Ti₂C, B₄C, and the like; metal organic framework (MOF)-based host including, for example only, Ni-based-MOFs, Ce-based-MOFs, and the like; and hybrids or combinations thereof (e.g., polypyrrole/graphene, vanadium nitride/graphene, and the like). In still other variations, the sulfur host material may include MgB₂, TiCl₂, phosphorene, C₃B, Li₄Ti₅O₁₂, and the like. Such sulfur host materials may enhance electron transfer at the sulfur/host interface, accommodate volumetric changes within the cell 20, minimize polysulfide shuttles, and/or promote conversions among polysulfide intermediates.

The positive electroactive materials defining the positive electrodes 24 may be optionally intermingled with an electronically conducting material that provides an electron conduction path and/or at least one polymeric binder material that improves the structural integrity of the electrode. For example, the positive electroactive materials and electronically or electrically conducting materials may be slurry cast with such binders, like polyvinylidene difluoride (PVdF), polytetrafluoroethylene (PTFE), poly(ethylene oxide) (PEO), poly(vinylpyrrolidone) (PVP), poly(ethylene glycol) (PEG), ethylene propylene diene monomer (EPDM) rubber, or carboxymethyl cellulose (CMC), nitrile butadiene rubber (NBR), styrene-butadiene rubber (SBR), styrene ethylene butylene styrene copolymer (SEBS), styrene butadiene styrene copolymer (SBS), polyacrylate (PAA), lithium polyacrylate (LiPAA), sodium polyacrylate (NaPAA), sodium alginate, or lithium alginate. Electrically conducting materials may include carbon-based materials, powdered nickel or other metal particles (e.g., metal wire and/or metal oxides), or a conductive polymer. Carbon-based materials may include, for example, particles of graphite, acetylene black (such as KETCHEN™ black or DENKA™ black), carbon fibers and nanotubes (e.g., vapor grown carbon fibers (VGCF)), graphene, graphene oxide, and the like. Examples of a conductive polymer include polyaniline, polythiophene, polyacetylene, polypyrrole, and the like. In certain aspects, mixtures of the conductive materials may be used.

For example, each positive electrode 24 may include greater than or equal to about 20 wt. % to less than or equal to about 98 wt. %, and in certain aspects, optionally greater than or equal to about 60 wt. % to less than or equal to about 90 wt. %, of the sulfur-containing electroactive material; greater than or equal to about 2 wt. % to less than or equal to about 60 wt. %, and in certain aspects, optionally greater than or equal to about 10 wt. % to less than or equal to about 30 wt. %, of the sulfur host material; greater than or equal to about 0 wt. % to less than or equal to about 30 wt. %, and in certain aspects, optionally greater than or equal to about 0.5 wt. % to less than or equal to about 15 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders. The positive electrodes 24 may have thicknesses greater than or equal to about 1 μm to less than or equal to about 1000 μm.

As noted above, the capacitor electrode 30 may be a positive capacitor electrode (e.g., capacitor cathode), or in certain other aspects, a negative capacitor electrode (e.g., capacitor anode), as discussed below. The positive capacitor electrode 30 may have a thickness greater than or equal to about 1 μm to less than or equal to about 1000 μm, and in certain aspects, optionally greater than or equal to about 20 μm to less than or equal to about 300 μm. The positive capacitor electrode 30 may include a capacitor active material, for example, a positive capacitor active material. The positive capacitor active material may include, for example only, activated carbon, graphene, carbon nanotubes, other porous carbon materials, conducting polymers (e.g., PEDOT), and the like.

The positive capacitor active material defining the positive capacitor electrode 30 may be optionally intermingled with an electronically conducting material that provides an electron conduction path and/or at least one polymeric binder material that improves the structural integrity of the electrode. For example, the positive capacitor active material and electronically or electrically conducting materials may be slurry cast with such binders, like polyvinylidene difluoride (PVdF), polytetrafluoroethylene (PTFE), poly(ethylene oxide) (PEO), poly(vinylpyrrolidone) (PVP), poly(ethylene glycol) (PEG), ethylene propylene diene monomer (EPDM) rubber, or carboxymethyl cellulose (CMC), nitrile butadiene rubber (NBR), styrene-butadiene rubber (SBR), styrene ethylene butylene styrene copolymer (SEBS), styrene butadiene styrene copolymer (SBS), polyacrylate (PAA), lithium polyacrylate (LiPAA), sodium polyacrylate (NaPAA), sodium alginate, or lithium alginate. Electrically conducting materials may include carbon-based materials, powdered nickel or other metal particles (e.g., metal wire and/or metal oxides), or a conductive polymer. Carbon-based materials may include, for example, particles of graphite, acetylene black (such as KETCHEN™ black or DENKA™ black), carbon fibers and nanotubes (e.g., vapor grown carbon fibers (VGCF)), graphene, graphene oxide, and the like. Examples of a conductive polymer include polyaniline, polythiophene, polyacetylene, polypyrrole, and the like. In certain aspects, mixtures of the conductive materials may be used.

For example, the positive capacitor electrode 30 may include greater than or equal to about 40 wt. % to less than or equal to about 98 wt. %, and in certain aspects, optionally greater than or equal to about 60 wt. % to less than or equal to about 95 wt. %, of the positive capacitor active material; greater than or equal to about 0 wt. % to less than or equal to about 30 wt. %, and in certain aspects, optionally greater than or equal to about 0.5 wt. % to less than or equal to about 15 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders.

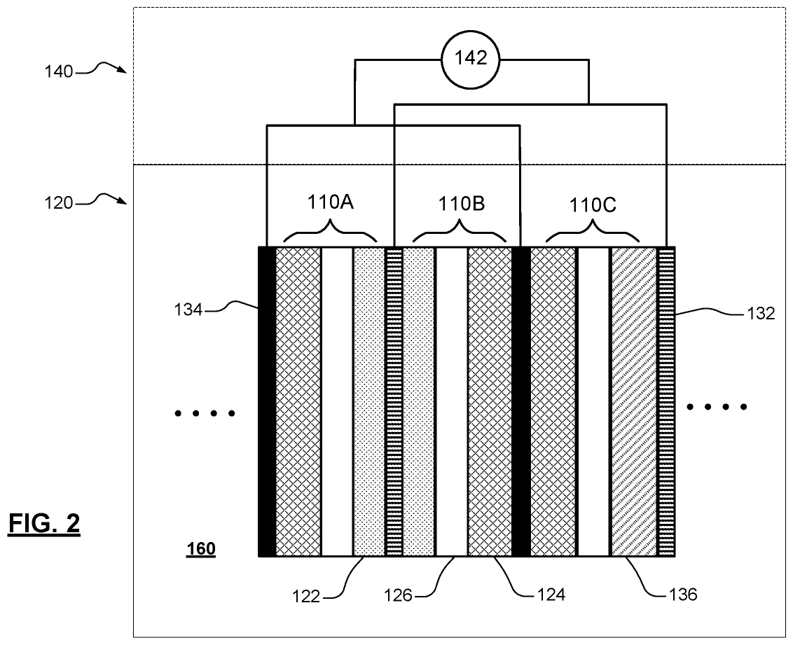

An exemplary and schematic illustration of another example capacitor-assisted lithium-sulfur electrochemical cell (also referred to as the battery 120 is shown in FIG. 2. Like the capacitor-assisted lithium-sulfur battery 20 illustrated in FIG. 1, the capacitor-assisted battery 120 includes a plurality of cells 110A-110C. Each cell 110A-110C includes a negative electrode 122 (e.g., anode), a positive electrode 124 (e.g., cathode), and a separator 126 disposed between the two electrodes 122, 124. At least one of the cells 110A-110C, includes a capacitor electrode 136 in place of one of the electrodes 122, 124. For example, as illustrated, a capacitor electrode (e.g., lithium-ion capacitor anode) 136 may be disposed in place of the anode 122 in a third cell 110C. In each instance, the separator 126 provides electrical separation (e.g., prevents physical contact) between the electrodes 122, 124, 136. In various aspects, the separator 126 comprises an electrolyte 160 that may, in certain aspects, also be present in the negative electrode 122, positive electrode 124, and/or capacitor electrode 136.

Similar to battery 20, battery 120 includes one or more negative electrode current collectors 132 and positive electrode current collectors 134. A negative electrode current collector 132 may be positioned at or near each negative electrode 122 and/or capacitor electrode 136, and a positive electrode current collector 134 may be positioned at or near each positive electrode 124. The negative electrode current collectors 132 and the positive electrode current collectors 134 respectively collect and move free electrons to and from an external circuit 140. For example, an interruptible external circuit 140 and a load device 142 may connect the positive electrodes 124 (through the positive electrode current collectors 134) and the negative electrodes 122 (through the negative electrode current collectors 132) and/or capacitor electrodes 136 (through the negative electrode current collectors 132).

Like negative electrodes 22, each negative electrode 122 may include a negative electroactive material that comprises lithium, such as, for example, lithium metal. In certain variations, the negative electrodes 122 are films or layers formed of lithium metal or an alloy of lithium. Like positive electrodes 24, each positive electrode 124 may include a positive electroactive material that comprises sulfur. The positive electrode 124 may include a sulfur-containing electroactive material and a sulfur host material. The positive electrode 124 may include greater than or equal to about 20 wt. % to less than or equal to about 98 wt. %, and in certain aspects, optionally greater than or equal to about 60 wt. % to less than or equal to about 90 wt. %, of the sulfur-containing electroactive material, and greater than or equal to about 2 wt. % to less than or equal to about 60 wt. %, and in certain aspects, optionally greater than or equal to about 10 wt. % to less than or equal to about 30 wt. %, of the sulfur host material.

The capacitor electrode 136 may be a negative capacitor electrode (e.g., capacitor anode). The capacitor electrode 136 may have a thickness greater than or equal to about 1 μm to less than or equal to about 1000 μm, and in certain aspects, optionally greater than or equal to about 20 μm to less than or equal to about 300 μm. The capacitor electrode 136 may include a lithiated capacitor active material, for example, a lithiated negative capacitor active material that provides lithium (e.g., lithium source) for the electrochemical reaction. The negative capacitor active material may include, for example only, lithiated activated carbon, lithiated soft carbon, lithiated hard carbon, lithiated metal oxides, lithiated metal sulfides, and the like.

The lithiated negative capacitor active material defining the negative capacitor electrode 136 may be optionally intermingled with an electronically conducting material that provides an electron conduction path and/or at least one polymeric binder material that improves the structural integrity of the electrode. For example, the negative capacitor active material and electronically or electrically conducting materials may be slurry cast with such binders, like polyvinylidene difluoride (PVdF), polytetrafluoroethylene (PTFE), poly(ethylene oxide) (PEO), poly(vinylpyrrolidone) (PVP), poly(ethylene glycol) (PEG), ethylene propylene diene monomer (EPDM) rubber, or carboxymethyl cellulose (CMC), nitrile butadiene rubber (NBR), styrene-butadiene rubber (SBR), styrene ethylene butylene styrene copolymer (SEBS), styrene butadiene styrene copolymer (SBS), polyacrylate (PAA), lithium polyacrylate (LiPAA), sodium polyacrylate (NaPAA), sodium alginate, or lithium alginate. Electrically conducting materials may include carbon-based materials, powdered nickel or other metal particles (e.g., metal wire and/or metal oxides), or a conductive polymer. Carbon-based materials may include, for example, particles of graphite, acetylene black (such as KETCHEN™ black or DENKA™ black), carbon fibers and nanotubes (e.g., vapor grown carbon fibers (VGCF)), graphene, graphene oxide, and the like. Examples of a conductive polymer include polyaniline, polythiophene, polyacetylene, polypyrrole, and the like. In certain aspects, mixtures of the conductive materials may be used.

For example, the negative capacitor electrode 136 may include greater than or equal to about 40 wt. % to less than or equal to about 98 wt. %, and in certain aspects, optionally greater than or equal to about 60 wt. % to less than or equal to about 90 wt. %, of the negative capacitor active material; greater than or equal to about 0 wt. % to less than or equal to about 30 wt. %, and in certain aspects, optionally greater than or equal to about 0.5 wt. % to less than or equal to about 15 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders.

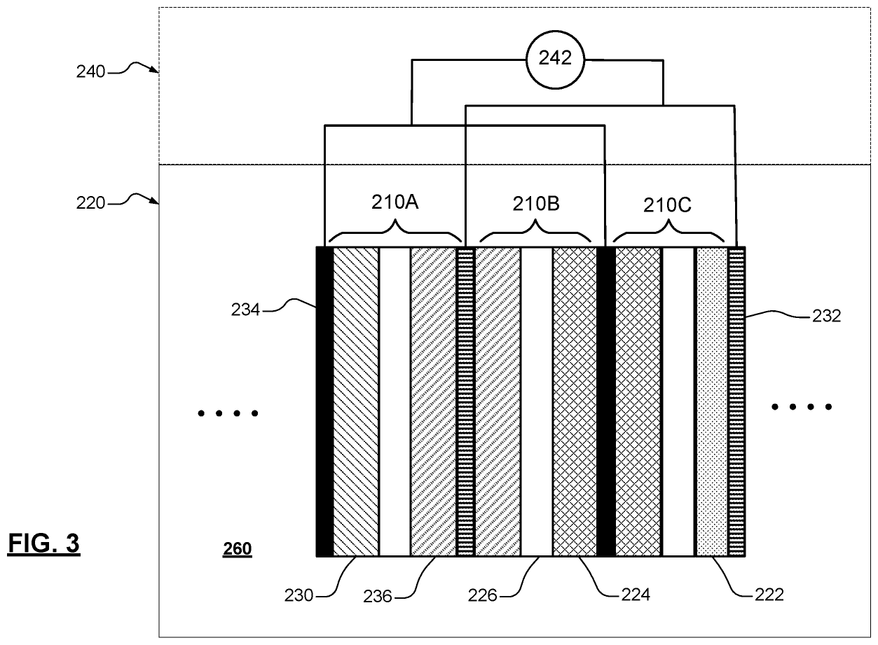

An exemplary and schematic illustration of another example capacitor-assisted lithium-sulfur electrochemical cell (also referred to as the battery) 220 is shown in FIG. 3. Like the capacitor-assisted lithium-sulfur battery 20 illustrated in FIG. 1, the capacitor-assisted lithium-sulfur battery 220 includes a plurality of cells 210A-210C. Each cell 210A-210C includes a negative electrode 222 (e.g., anode), a positive electrode 224 (e.g., cathode), and a separator 226 disposed between the two electrodes 222, 224. At least one of the cells 210A-210C, includes a capacitor electrode 230, 236 in place of one of the electrodes 222, 224. For example, as illustrated, a negative capacitor electrode (e.g., lithium-ion capacitor anode) 236 may be disposed in place of the anode 222 in the second cell 210B. Further, each electrode 222, 224 in the first cell 210A may be replaced by capacitor electrodes 230, 236. For example, the first cell 210A may include a positive capacitor electrode 230, a negative capacitor electrode 236, and a separator 236 disposed therebetween. In each instance, the separator 226 provides electrical separation (e.g., prevents physical contact) between the electrodes 222, 224, 230, 236. In various aspects, the separator 226 comprises an electrolyte 260 that may, in certain aspects, also be present in the negative electrode 222, positive electrode 224, and/or capacitor electrode 236.

Similar to battery 20, battery 220 includes one or more negative electrode current collectors 232 and positive electrode current collectors 234. A negative electrode current collector 232 may be positioned at or near each negative electrode 222 and/or capacitor electrode 236, and a positive electrode current collector 234 may be positioned at or near each positive electrode 224. The negative electrode current collectors 232 and the positive electrode current collectors 234 respectively collect and move free electrons to and from an external circuit 240. For example, an interruptible external circuit 240 and a load device 242 may connect the positive electrodes 224 (through the positive electrode current collectors 234) and/or the positive capacitor electrodes 230 (through the positive electrode current collectors 234) and the negative electrodes 222 (through the negative electrode current collectors 232) and/or negative capacitor electrodes 236 (through the negative electrode current collectors 232).

Like negative electrodes 22, each negative electrode 222 comprises a lithium host material may include a negative electroactive material that comprises lithium, such as, for example, lithium metal. In certain variations, the negative electrodes 222 are films or layers formed of lithium metal or an alloy of lithium. Like positive electrodes 24, each positive electrode 224 may include a positive electroactive material that comprises sulfur. The positive electrode 224 may include a sulfur-containing electroactive material and a sulfur host material. The positive electrode 224 may include greater than or equal to about 20 wt. % to less than or equal to about 98 wt. %, and in certain aspects, optionally greater than or equal to about 60 wt. % to less than or equal to about 90 wt. %, of the sulfur-containing electroactive material, and greater than or equal to about 2 wt. % to less than or equal to about 60 wt. %, and in certain aspects, optionally greater than or equal to about 10 wt. % to less than or equal to about 30 wt. %, of the sulfur host material.

Like the positive capacitor electrode 30, the positive capacitor electrode 230 may be a composite positive electrode (e.g., capacitor cathode) comprising a positive capacitor active material. For example, the positive capacitor electrode 230 may include, for example only, activated carbon, graphene, carbon nanotubes, other porous carbon materials, conducting polymers (e.g., PEDOT), and the like. The positive capacitor electrode 230 may have a thickness greater than or equal to about 1 μm to less than or equal to about 1000 μm, and in certain aspects, optionally greater than or equal to about 20 μm to less than or equal to about 300 μm.

The positive capacitor active material defining the positive capacitor electrode 230 may be optionally intermingled with an electronically conducting material that provides an electron conduction path and/or at least one polymeric binder material that improves the structural integrity of the electrode. For example, the positive capacitor electrode 230 may include greater than or equal to about 40 wt. % to less than or equal to about 98 wt. %, and in certain aspects, optionally greater than or equal to about 60 wt. % to less than or equal to about 95 wt. %, of the positive capacitor active material; greater than or equal to about 0 wt. % to less than or equal to about 30 wt. %, and in certain aspects, optionally greater than or equal to about 0.5 wt. % to less than or equal to about 15 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders.

Like the negative capacitor electrode 136, the negative capacitor electrode 236 may be a composite negative electrode (e.g., capacitor anode) comprising a negative capacitor active material, for example, a lithiated negative capacitor active material that provides lithium (e.g., lithium source) for the electrochemical reaction. The negative capacitor active material may include, for example only, lithiated activated carbon, lithiated soft carbon, lithiated hard carbon, lithiated metal oxides, lithiated metal sulfides, and the like. The negative capacitor electrode 236 may have a thickness greater than or equal to about 1 μm to less than or equal to about 1000 μm, and in certain aspects, optionally greater than or equal to about 20 μm to less than or equal to about 300 μm.

The negative capacitor active material defining the negative capacitor electrode 236 may be optionally intermingled with an electronically conducting material that provides an electron conduction path and/or at least one polymeric binder material that improves the structural integrity of the electrode. For example, the negative capacitor electrode 236 may include greater than or equal to about 40 wt. % to less than or equal to about 98 wt. %, and in certain aspects, optionally greater than or equal to about 60 wt. % to less than or equal to about 95 wt. %, of the negative capacitor active material; greater than or equal to about 0 wt. % to less than or equal to about 30 wt. %, and in certain aspects, optionally greater than or equal to about 0.5 wt. % to less than or equal to about 15 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders.

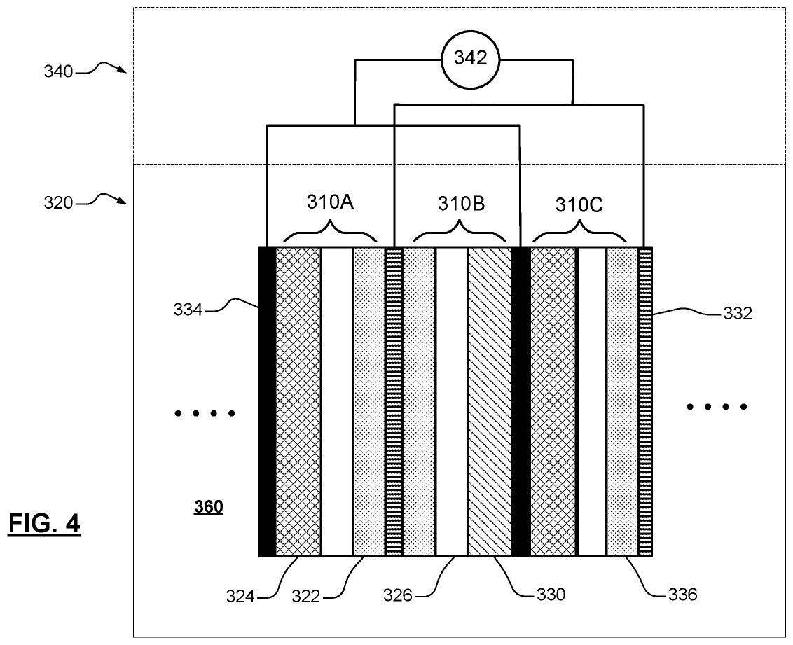

An exemplary and schematic illustration of another example capacitor-assisted lithium-sulfur electrochemical cell (also referred to as the battery) 320 is shown in FIG. 4. Like the capacitor-assisted lithium-sulfur battery 20 illustrated in FIG. 1, the capacitor-assisted lithium-sulfur battery 320 includes a plurality of cells 310A-310C. Each cell 310A-310C includes a negative electrode 322 (e.g., anode), a positive electrode 324 (e.g., cathode), and a separator 326 disposed between the two electrodes 322, 324. At least one of the cells 310A-310C, includes a capacitor electrode 330 in place of one of the electrodes 322, 324. For example, as illustrated, a positive capacitor electrode (e.g., lithium-ion capacitor cathode) 330 may be disposed in place of the cathode 324 in a second cell 310B so as to form an asymmetric cathode electrode. In each instance, the separator 326 provides electrical separation (e.g., prevents physical contact) between the electrodes 322, 324, 330. In various aspects, the separator 326 comprises an electrolyte 360 that may, in certain aspects, also be present in the negative electrode 322, positive electrode 324, and/or positive capacitor electrode 330.

Similar to battery 20, battery 320 includes one or more negative electrode current collectors 332 and positive electrode current collectors 334. A negative electrode current collector 332 may be positioned at or near each negative electrode 322, and a positive electrode current collector 334 may be positioned at or near each positive electrode 324 and/or positive capacitor electrode 330. The negative electrode current collectors 332 and the positive electrode current collectors 334 respectively collect and move free electrons to and from an external circuit 340. For example, an interruptible external circuit 340 and a load device 342 may connect the negative electrodes 322 (through the negative electrode current collectors 332) and the positive electrodes 324 (through the positive electrode current collectors 334) and/or positive capacitor electrodes 330 (through the positive electrode current collectors 334).

Like negative electrodes 22, each negative electrode 322 comprises a lithium host material may include a negative electroactive material that comprises lithium, such as, for example, lithium metal. In certain variations, the negative electrodes 322 are films or layers formed of lithium metal or an alloy of lithium. Like positive electrodes 24, each positive electrode 324 may include a positive electroactive material that comprises sulfur. The positive electrode 324 may include a sulfur-containing electroactive material and a sulfur host material. The positive electrode 324 may include greater than or equal to about 20 wt. % to less than or equal to about 98 wt. %, and in certain aspects, optionally greater than or equal to about 60 wt. % to less than or equal to about 90 wt. %, of the sulfur-containing electroactive material, and greater than or equal to about 2 wt. % to less than or equal to about 60 wt. %, and in certain aspects, optionally greater than or equal to about 10 wt. % to less than or equal to about 30 wt. %, of the sulfur host material.

Like the positive capacitor electrode 30, the positive capacitor electrode 330 may be a composite positive electrode (e.g., capacitor cathode) comprising a positive capacitor active material. For example, the positive capacitor electrode 330 may include, for example only, activated carbon, graphene, carbon nanotubes, other porous carbon materials, conducting polymers (e.g., PEDOT), and the like. The positive capacitor electrode 330 may have a thickness greater than or equal to about 1 μm to less than or equal to about 1000 μm, and in certain aspects, optionally greater than or equal to about 20 μm to less than or equal to about 300 μm.

The positive capacitor active material defining the positive capacitor electrode 330 may be optionally intermingled with an electronically conducting material that provides an electron conduction path and/or at least one polymeric binder material that improves the structural integrity of the electrode. For example, the positive capacitor electrode 330 may include greater than or equal to about 40 wt. % to less than or equal to about 98 wt. %, and in certain aspects, optionally greater than or equal to about 60 wt. % to less than or equal to about 95 wt. %, of the positive capacitor active material; greater than or equal to about 0 wt. % to less than or equal to about 30 wt. %, and in certain aspects, optionally greater than or equal to about 0.5 wt. % to less than or equal to about 15 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders.

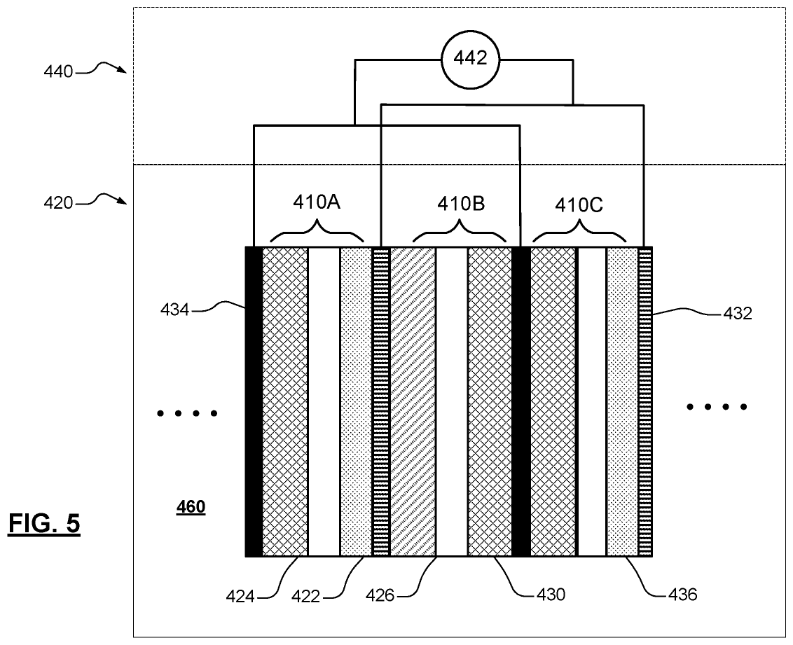

An exemplary and schematic illustration of another example capacitor-assisted lithium-sulfur electrochemical cell (also referred to as the battery) 420 is shown in FIG. 5. Like the capacitor-assisted lithium-sulfur battery 20 illustrated in FIG. 1, the capacitor-assisted lithium-sulfur battery 420 includes a plurality of cells 410A-410C. Each cell 410A-410C includes a negative electrode 422 (e.g., anode), a positive electrode 424 (e.g., cathode), and a separator 426 disposed between the two electrodes 422, 424. At least one of the cells 410A-410C, includes a capacitor electrode 436 in place of one of the electrodes 422, 424. For example, as illustrated, a negative capacitor electrode (e.g., lithium-ion capacitor anode) 436 may be disposed in place of the anode 424 in a second cell 410B so as to form an asymmetric anode electrode. In each instance, the separator 426 provides electrical separation (e.g., prevents physical contact) between the electrodes 422, 424, 436. In various aspects, the separator 426 comprises an electrolyte 460 that may, in certain aspects, also be present in the negative electrode 422, positive electrode 424, and/or negative capacitor electrode 436.

Similar to battery 20, battery 420 includes one or more negative electrode current collectors 432 and positive electrode current collectors 434. A negative electrode current collector 432 may be positioned at or near each negative electrode 422 and/or negative capacitor electrode 436, and a positive electrode current collector 434 may be positioned at or near each positive electrode 424. The negative electrode current collectors 432 and the positive electrode current collectors 434 respectively collect and move free electrons to and from an external circuit 440. For example, an interruptible external circuit 440 and a load device 442 may connect the positive electrodes 424 and the negative electrodes 422 (through the negative electrode current collectors 432) and/or negative capacitor electrodes 436 (through the negative electrode current collectors 432).

Like negative electrodes 22, each negative electrode 422 comprises a lithium host material may include a negative electroactive material that comprises lithium, such as, for example, lithium metal. In certain variations, the negative electrodes 422 are films or layers formed of lithium metal or an alloy of lithium. Like positive electrodes 24, each positive electrode 424 may include a positive electroactive material that comprises sulfur. The positive electrode 424 may include a sulfur-containing electroactive material and a sulfur host material. The positive electrode 424 may include greater than or equal to about 20 wt. % to less than or equal to about 98 wt. %, and in certain aspects, optionally greater than or equal to about 60 wt. % to less than or equal to about 90 wt. %, of the sulfur-containing electroactive material, and greater than or equal to about 2 wt. % to less than or equal to about 60 wt. %, and in certain aspects, optionally greater than or equal to about 10 wt. % to less than or equal to about 30 wt. %, of the sulfur host material.

Like the negative capacitor electrode 136, the negative capacitor electrode 436 may be a composite negative electrode (e.g., capacitor anode) comprising a negative capacitor active material, for example, a lithiated negative capacitor active material that provides lithium (e.g., lithium source) for the electrochemical reaction. The negative capacitor active material may include, for example only, lithiated activated carbon, lithiated soft carbon, lithiated hard carbon, lithiated metal oxides, lithiated metal sulfides, and the like. The negative capacitor electrode 436 may have a thickness greater than or equal to about 1 μm to less than or equal to about 1000 μm, and in certain aspects, optionally greater than or equal to about 20 μm to less than or equal to about 300 μm.

The negative capacitor active material defining the negative capacitor electrode 436 may be optionally intermingled with an electronically conducting material that provides an electron conduction path and/or at least one polymeric binder material that improves the structural integrity of the electrode. For example, the negative capacitor electrode 436 may include greater than or equal to about 40 wt. % to less than or equal to about 98 wt. %, and in certain aspects, optionally greater than or equal to about 60 wt. % to less than or equal to about 95 wt. %, of the negative capacitor active material; greater than or equal to about 0 wt. % to less than or equal to about 30 wt. %, and in certain aspects, optionally greater than or equal to about 0.5 wt. % to less than or equal to about 15 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders.

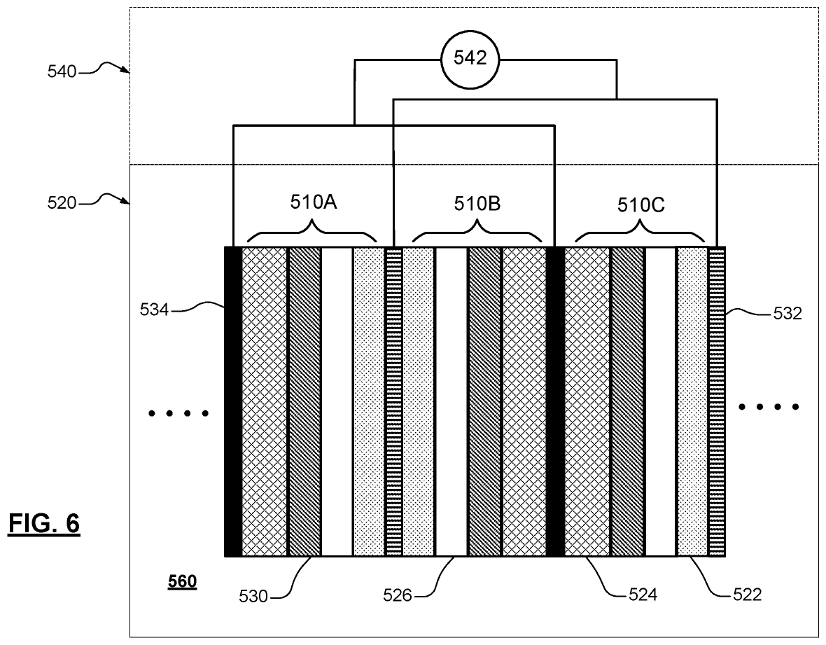

An exemplary and schematic illustration of another example capacitor-assisted lithium-sulfur electrochemical cell (also referred to as the battery) 520 is shown in FIG. 6. Like the lithium-sulfur capacitor-assisted battery 20 illustrated in FIG. 1, the capacitor-assisted lithium-sulfur battery 520 includes a plurality of cells 510A-510C. Each cell 510A-510C includes a negative electrode 522 (e.g., anode), a positive electrode 524 (e.g., cathode), and a separator 526 disposed between the two electrodes 522, 524. One or more of the cells 510A-510C includes a capacitor-based interlayer 530 disposed between the separator 526 and one of the negative electrode 522 and/or positive electrode 524. For example, as illustrated, a first capacitor-based interlayer 530 may be disposed between the positive electrode 524 and the separator 526 in the first cell 510A; a second capacitor-based interlayer 530 may be disposed between the positive electrode 524 and the separator 526 in the second cell 510B; and a third capacitor-based interlayer 530 may be disposed between the positive electrode 524 and the separator 526 in the third cell 510C. In each instance, the separator 526 provides electrical separation (e.g., prevents physical contact) between the electrodes 522, 524 and/or interlayer 530. In various aspects, the separator 526 comprises an electrolyte 560 that may, in certain aspects, also be present in the negative electrode 522, positive electrode 524, and/or capacitor-base interlayer 530.

The capacitor-based interlayer 530 has a thickness greater than or equal to about 0.1 μm to less than or equal to about 100 μm and comprises a capacitor active material. The capacitor active material may be a positive capacitor active material. The positive capacitor active material may include, for example only, activated carbon, graphene, carbon nanotubes, other porous carbon materials, conducting polymers (e.g., PEDOT), and the like. The positive capacitor active material defining capacitor-based interlayer 530 may be optionally intermingled with an electronically conducting material that provides an electron conduction path and/or at least one polymeric binder material that improves the structural integrity of the electrode.

For example, the capacitor-based interlayer 530 may include greater than or equal to about 40 wt. % to less than or equal to about 98 wt. %, and in certain aspects, optionally greater than or equal to about 60 wt. % to less than or equal to about 95 wt. %, of the positive capacitor active material; greater than or equal to about 0 wt. % to less than or equal to about 30 wt. %, and in certain aspects, optionally greater than or equal to about 0.5 wt. % to less than or equal to about 15 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders. The capacitor-based interlayer 530 may be formed by coating the interlayer 530 onto one of the positive electrode 524 and the separator 526.

Similar to battery 20, battery 520 includes one or more negative electrode current collectors 532 and positive electrode current collectors 534. A negative electrode current collector 532 may be positioned at or near each negative electrode 522, and a positive electrode current collector 534 may be positioned at or near each positive electrode 524. The negative electrode current collectors 532 and the positive electrode current collectors 534 respectively collect and move free electrons to and from an external circuit 540. For example, an interruptible external circuit 540 and a load device 542 may connect the positive electrodes 524 (through the positive electrode current collectors 534) and the negative electrodes 522 (through the negative electrode current collectors 532).

Like negative electrodes 22, each negative electrode 522 comprises a lithium host material may include a negative electroactive material that comprises lithium, such as, for example, lithium metal. In certain variations, the negative electrodes 522 are films or layers formed of lithium metal or an alloy of lithium. Like positive electrodes 24, each positive electrode 524 may include a positive electroactive material that comprises sulfur. The positive electrode 524 may include a sulfur-containing electroactive material and a sulfur host material. The positive electrode 524 may include greater than or equal to about 20 wt. % to less than or equal to about 98 wt. %, and in certain aspects, optionally greater than or equal to about 60 wt. % to less than or equal to about 90 wt. %, of the sulfur-containing electroactive material, and greater than or equal to about 2 wt. % to less than or equal to about 60 wt. %, and in certain aspects, optionally greater than or equal to about 10 wt. % to less than or equal to about 30 wt. %, of the sulfur host material.

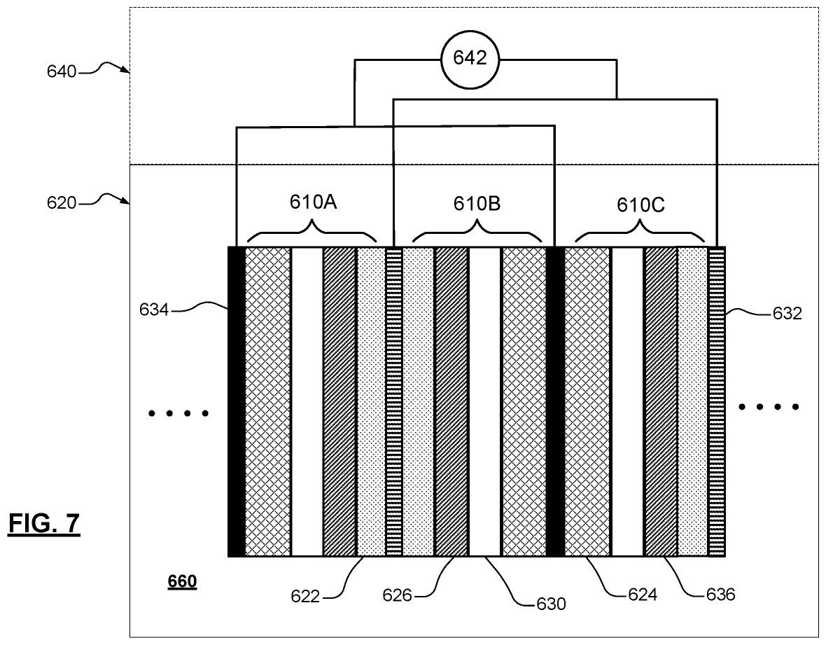

An exemplary and schematic illustration of another example capacitor-assisted lithium-sulfur electrochemical cell (also referred to as the battery) 620 is shown in FIG. 7. Like the capacitor-assisted lithium-sulfur battery 20 illustrated in FIG. 1, the capacitor-assisted lithium-sulfur battery 620 includes a plurality of cells 610A-610C. Each cell 610A-610C includes a negative electrode 622 (e.g., anode), a positive electrode 624 (e.g., cathode), and a separator 626 disposed between the two electrodes 622, 624. One or more of the cells 610A-610C includes a capacitor-based interlayer 636 disposed between the separator 626 and one of the negative electrode 622 and/or positive electrode 624. For example, as illustrated, a first capacitor-based interlayer 630 may be disposed between the negative electrode 622 and the separator 626 in the first cell 610A; a second capacitor-based interlayer 630 may be disposed between the negative electrode 622 and the separator 626 in the second cell 610B; and a third capacitor-based interlayer 630 may be disposed between the negative electrode 622 and the separator 626 in the third cell 610C. In each instance, the separator 626 provides electrical separation (e.g., prevents physical contact) between the electrodes 622, 624 and/or interlayer 636. In various aspects, the separator 626 comprises an electrolyte 660 that may, in certain aspects, also be present in the negative electrode 622, positive electrode 624, and/or negative capacitor electrode 636.

The capacitor-based interlayer 636 has a thickness greater than or equal to about 0.1 μm to less than or equal to about 100 μm and comprises a capacitor active material. The capacitor active material may be a negative capacitor active material. The negative capacitor active material may include, for example only, lithiated activated carbon, lithiated soft carbon, lithiated hard carbon, lithiated metal oxides, lithiated metal sulfides, and the like. The negative capacitor active material defining capacitor-based interlayer 636 may be optionally intermingled with an electronically conducting material that provides an electron conduction path and/or at least one polymeric binder material that improves the structural integrity of the electrode.

For example, the capacitor-based interlayer 636 may include greater than or equal to about 40 wt. % to less than or equal to about 98 wt. %, and in certain aspects, optionally greater than or equal to about 60 wt. % to less than or equal to about 95 wt. %, of the negative capacitor active material; greater than or equal to about 0 wt. % to less than or equal to about 30 wt. %, and in certain aspects, optionally greater than or equal to about 0.5 wt. % to less than or equal to about 15 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders. The capacitor-based interlayer 636 may be formed by coating the interlayer 636 onto one of the negative electrode 622 and the separator 626.

Similar to battery 20, battery 620 includes one or more negative electrode current collectors 632 and positive electrode current collectors 634. A negative electrode current collector 632 may be positioned at or near each negative electrode 622, and a positive electrode current collector 634 may be positioned at or near each positive electrode 624. The negative electrode current collectors 632 and the positive electrode current collectors 634 respectively collect and move free electrons to and from an external circuit 640. For example, an interruptible external circuit 640 and a load device 642 may connect the positive electrodes 624 (through the positive electrode current collectors 634) and the negative electrodes 622 (through the negative electrode current collectors 632).

Like negative electrodes 22, each negative electrode 622 comprises a lithium host material may include a negative electroactive material that comprises lithium, such as, for example, lithium metal. In certain variations, the negative electrodes 622 are films or layers formed of lithium metal or an alloy of lithium. Like positive electrodes 24, each positive electrodes 624 may include a positive electroactive material that comprises sulfur. The positive electrode 624 may include a sulfur-containing electroactive material and a sulfur host material. The positive electrode 624 may include greater than or equal to about 20 wt. % to less than or equal to about 98 wt. %, and in certain aspects, optionally greater than or equal to about 60 wt. % to less than or equal to about 90 wt. %, of the sulfur-containing electroactive material, and greater than or equal to about 2 wt. % to less than or equal to about 60 wt. %, and in certain aspects, optionally greater than or equal to about 10 wt. % to less than or equal to about 30 wt. %, of the sulfur host material.

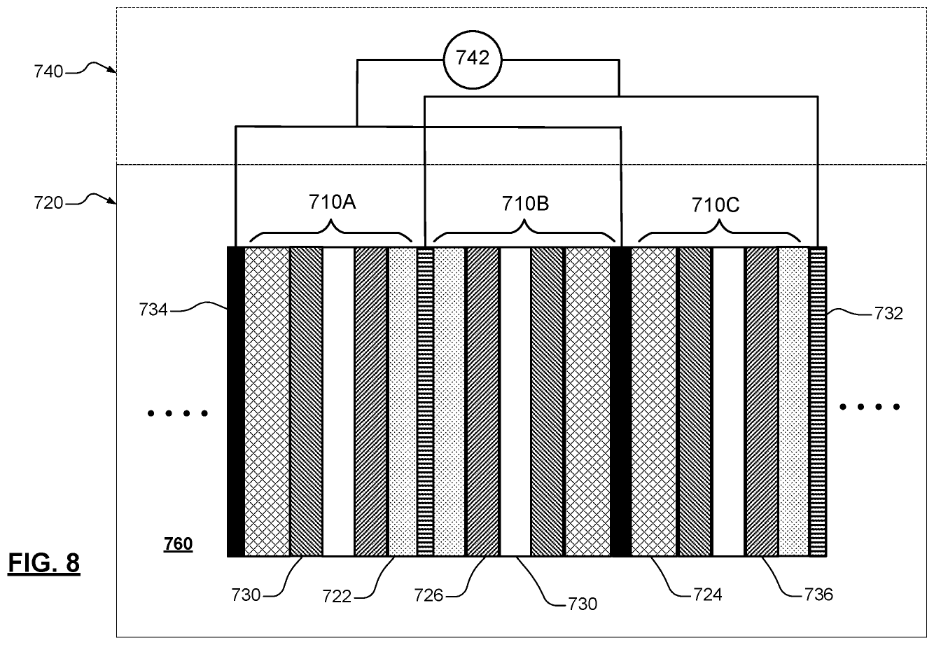

An exemplary and schematic illustration of another example capacitor-assisted lithium-sulfur electrochemical cell (also referred to as the battery) 720 is shown in FIG. 8. Like the capacitor-assisted lithium-sulfur battery 20 illustrated in FIG. 1, the capacitor-assisted lithium-sulfur battery 720 includes a plurality of cells 710A-710C. Each cell 710A-710C includes a negative electrode 722 (e.g., anode), a positive electrode 724 (e.g., cathode), and a separator 726 disposed between the two electrodes 722, 724. One or more of the cells 710A-710C includes one or more capacitor-based interlayers 730, 736 disposed between the separator 726 and one of the negative electrode 722 and/or positive electrode 724. For example, as illustrated, a first positive capacitor-based interlayer 730 may be disposed between the positive electrode 724 and the separator 726 and a first negative capacitor-based interlayer 736 may be disposed between the negative electrode 722 and the separator 726 in the first cell 710A; a second positive capacitor-based interlayer 730 may be disposed between the positive electrode 724 and the separator 726 and a second negative capacitor-based interlayer 736 may be disposed between the negative electrode 722 and the separator 726 in the second cell 710B; and a third positive capacitor-based interlayer 730 may be disposed between the positive electrode 724 and the separator 726 and a third negative capacitor-based interlayer 736 may be disposed between the negative electrode 722 and the separator 726 in the third cell 710C.

The positive capacitor-based interlayer 730 has a thickness greater than or equal to about 0.1 μm to less than or equal to about 100 μm and comprises a positive capacitor active material. The positive capacitor active material may include, for example only, activated carbon, graphene, carbon nanotubes, other porous carbon materials, conducting polymers (e.g., PEDOT), and the like. The positive capacitor active material defining capacitor-based interlayer 730 may be optionally intermingled with an electronically conducting material that provides an electron conduction path and/or at least one polymeric binder material that improves the structural integrity of the electrode.

For example, the positive capacitor-based interlayer 730 may include greater than or equal to about 40 wt. % to less than or equal to about 98 wt. %, and in certain aspects, optionally greater than or equal to about 60 wt. % to less than or equal to about 95 wt. %, of the positive capacitor active material; greater than or equal to about 0 wt. % to less than or equal to about 30 wt. %, and in certain aspects, optionally greater than or equal to about 0.5 wt. % to less than or equal to about 15 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders. The capacitor-based interlayer 730 may be formed by coating the interlayer 730 onto one of the positive electrode 724 and the separator 726.

The negative capacitor-based interlayer 736 has a thickness greater than or equal to about 0.1 μm to less than or equal to about 100 μm and comprises a negative capacitor active material. The negative capacitor active material may include, for example only, lithiated activated carbon, lithiated soft carbon, lithiated hard carbon, lithiated metal oxides, lithiated metal sulfides, and the like. The negative capacitor active material defining capacitor-based interlayer 736 may be optionally intermingled with an electronically conducting material that provides an electron conduction path and/or at least one polymeric binder material that improves the structural integrity of the electrode.

For example, the negative capacitor-based interlayer 736 may include greater than or equal to about 40 wt. % to less than or equal to about 98 wt. %, and in certain aspects, optionally greater than or equal to about 60 wt. % to less than or equal to about 95 wt. %, of the negative capacitor active material; greater than or equal to about 0 wt. % to less than or equal to about 30 wt. %, and in certain aspects, optionally greater than or equal to about 0.5 wt. % to less than or equal to about 15 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders. The negative capacitor-based interlayer 736 may be formed by coating the interlayer 736 onto one of the negative electrode 722 and the separator 726.

Similar to battery 20, battery 720 includes one or more negative electrode current collectors 732 and positive electrode current collectors 734. A negative electrode current collector 732 may be positioned at or near each negative electrode 722, and a positive electrode current collector 734 may be positioned at or near each positive electrode 724. The negative electrode current collectors 732 and the positive electrode current collectors 734 respectively collect and move free electrons to and from an external circuit 740. For example, an interruptible external circuit 740 and a load device 742 may connect the positive electrodes 724 (through the positive electrode current collectors 734) and the negative electrodes 722 (through the negative electrode current collectors 732).

Like negative electrodes 22, each negative electrode 722 comprises a lithium host material may include a negative electroactive material that comprises lithium, such as, for example, lithium metal. In certain variations, the negative electrodes 722 are films or layers formed of lithium metal or an alloy of lithium. Like positive electrodes 24, each positive electrodes 724 may include a positive electroactive material that comprises sulfur. The positive electrode 724 may include a sulfur-containing electroactive material and a sulfur host material. The positive electrode 724 may include greater than or equal to about 20 wt. % to less than or equal to about 98 wt. %, and in certain aspects, optionally greater than or equal to about 60 wt. % to less than or equal to about 90 wt. %, of the sulfur-containing electroactive material, and greater than or equal to about 2 wt. % to less than or equal to about 60 wt. %, and in certain aspects, optionally greater than or equal to about 10 wt. % to less than or equal to about 30 wt. %, of the sulfur host material.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A capacitor-assisted lithium-sulfur battery comprising two or more cells, wherein each cell comprises at least two electrodes selected from:
a first electrode comprising a sulfur-containing electroactive material;
a second electrode comprising a negative electroactive material;
a first capacitor electrode comprising a positive capacitor active material; and
a second capacitor electrode comprising a negative capacitor active material, wherein each electrode is disposed adjacent to a surface of a current collector and a separator is disposed between adjacent electrodes so as to provide electrical separation between the first and second electrodes, the first electrode and the second capacitor electrode, the second electrode and the first capacitor electrode, and the first and second capacitor electrodes, wherein one of the two or more cells includes the first electrode and the second electrode, and no cell includes both the first electrode and the first capacitor electrode or both the second electrode and the second capacitor electrode.

2. The capacitor-assisted lithium-sulfur battery of claim 1, wherein the first electrode further comprises a sulfur host material.

3. The capacitor-assisted lithium-sulfur battery of claim 2, wherein the first electrode comprises greater than or equal to about 20 wt. % to less than or equal to about 98 wt. % of the sulfur-containing electroactive material, and greater than or equal to about 2 wt. % to less than or equal to about 60 wt. % of the sulfur host material.

4. The capacitor-assisted lithium-sulfur battery of claim 2, wherein the sulfur host material is selected from the group consisting of: carbon nanotubes, amorphous carbon, porous carbon, carbon nanofibers, carbon spheres, carbon nanocage, graphene, graphene oxide, reduced graphene oxide, doped carbon, polyaniline (PAN), polypyrrole (PPy), polythiophene (Pt), polyaniline (PAni), poly(3,4-ethylenedioxythiophene:poly(styrenesulfonate) (PEDOT:PSS), TiO₂, SiO₂, CoS₂, Ti₄O₇, CeO₂, MoO₃, V₂O₅, SnO₂, Ni₃S₂, MoS₂, FeS, VS₂, TiS₂, TiS, CoS₂, Co₉S₈, NbS, VN, TiN, Ni₂N, CrN, ZrN, NbN, TiC, Ti₂C, B₄C, Ni-based-MOFs, Ce-based-MOFs, polypyrrole/graphene, vanadium nitride/graphene, MgB₂, TiCl₂, phosphorene, C₃B, Li₄Ti₅O₁₂, and combinations thereof.

5. The capacitor-assisted lithium-sulfur battery of claim 1, wherein the negative electroactive material comprises lithium metal.

6. The capacitor-assisted lithium-sulfur battery of claim 1, wherein the positive capacitor active material is selected from the group consisting of: activated carbon, graphene, carbon nanotubes, other porous carbon materials, conducting polymers, and combinations thereof.

7. The capacitor-assisted lithium-sulfur battery of claim 1, wherein the negative capacitor active material is selected from the group consisting of: lithiated activated carbon, lithiated soft carbon, lithiated hard carbon, lithiated metal oxides, lithiated metal sulfides, and combinations thereof.

8. The capacitor-assisted lithium-sulfur battery of claim 1, wherein each cell comprises the first electrode and the second electrode, and wherein each cell further comprises at least one capacitor-based interlayer.

9. The capacitor-assisted lithium-sulfur battery of claim 8, wherein the at least one capacitor-based interlayer is disposed between the first electrode and the separator.

10. The capacitor-assisted lithium-sulfur battery of claim 9, wherein the at least one capacitor-based interlayer comprises a positive capacitor active material, wherein the positive capacitor active material is selected from the group consisting of activated carbon, graphene, carbon nanotubes, other porous carbon materials, conducting polymers, and combinations thereof.

11. The capacitor-assisted lithium-sulfur battery of claim 8, wherein the at least one capacitor-based interlayer is disposed between the second electrode and the separator.

12. The capacitor-assisted lithium-sulfur battery of claim 11, wherein the at least one capacitor-based interlayer comprises a negative capacitor active material, wherein the negative capacitor active material is selected from the group consisting of: lithiated activated carbon, lithiated soft carbon, lithiated hard carbon, lithiated metal oxides, lithiated metal sulfides, and combinations thereof.

13. The capacitor-assisted lithium-sulfur battery of claim 8, wherein the at least one capacitor-based interlayer comprises a first capacitor-based layer and a second capacitor-based layer, wherein the first capacitor-based layer is disposed between the first electrode and the separator and the second capacitor-based interlayer is disposed between the second electrode and the separator, and wherein the first capacitor-based layer is a positive capacitor-based layer and the second capacitor-based interlayer is a negative capacitor-based layer.

14. The capacitor-assisted lithium-sulfur battery of claim 8, wherein the at least one capacitor-based layer has a thickness greater than or equal to about 0.1 μm to less than or equal to about 100 μm.

15. A capacitor-assisted lithium-sulfur electrochemical cell comprising:
a first current collector having a first surface;
a first electrode disposed adjacent to the first surface of the first current collector, the first electrode comprising a sulfur-containing electroactive material;
a second current collector having a first surface, wherein the first surface of the second current collector is substantially parallel with the first surface of first current collector;
a capacitor electrode disposed adjacent to the first surface of the second current collector, wherein the capacitor electrode comprises a negative capacitor active material; and
a separator disposed between the first electrode and the capacitor electrode.

16. The capacitor-assisted lithium-sulfur electrochemical cell of claim 15, wherein the first electrode further greater than or equal to about 2 wt. % to less than or equal to about 60 wt. % of a sulfur host material.

17. The capacitor-assisted lithium-sulfur electrochemical cell of claim 15, wherein the negative capacitor active material is selected from the group consisting of: lithiated activated carbon, lithiated soft carbon, lithiated hard carbon, lithiated metal oxides, lithiated metal sulfides, and combinations thereof.

18. A capacitor-assisted lithium-sulfur electrochemical cell comprising:
a first current collector having a first surface;
a first electrode disposed adjacent to the first surface of the first current collector, wherein the first electrode comprises a sulfur-containing electroactive material;
a second current collector having a first surface, wherein the first surface of the second current collector is substantially parallel with the first surface of first current collector;
a second electrode disposed adjacent to the first surface of the second current collector;
a separator disposed between the first and second electrodes; and
a capacitor-based interlayer disposed between one of the first electrode and the separator or the second electrode and the separator, wherein the capacitor-based interlayer has a thickness greater than or equal to about 0.1 μm to less than or equal to about 100 μm.

19. The capacitor-assisted lithium-sulfur electrochemical cell of claim 18, wherein the capacitor-based interlayer is disposed between the first electrode and the separator, wherein the capacitor-based interlayer comprises a positive capacitor active material, wherein the positive capacitor active material is selected from the group consisting of: activated carbon, graphene, carbon nanotubes, other porous carbon materials, conducting polymers, and combinations thereof.

20. The capacitor-assisted lithium-sulfur electrochemical cell of claim 18, wherein the capacitor-based interlayer is disposed between the second electrode and the separator, wherein the capacitor-based interlayer comprises a negative capacitor active material, wherein the negative capacitor active material is selected from the group consisting of: lithiated activated carbon, lithiated soft carbon, lithiated hard carbon, lithiated metal oxides, lithiated metal sulfides, and combinations thereof.
